(19) United States
(12) Patent Application Publication
(10) Pub. No.: US 2011/0312417 A1
(43) Pub. Date: Dec. 22, 2011

(54) Team play game device

(76) Inventor: Gordon MacKay, Cornwall (CA)

(21) Appl. No.: 12/802,929

(22) Filed: Jun. 17, 2010

(51) Int. Cl. A63F 13/06

(52) U.S. Cl. 463/38

(57) ABSTRACT

The Team Play Game Device creates the capability to have multiple players play computer games simultaneously without requiring games to be modified to support multiple players. It accomplishes this goal by making multiple game controllers look like single game controllers to the game device. It is a general game solution that can be applied to every game device and game controller combination including all game consoles and personal computers.

### FIELD OF THE INVENTION

This invention relates to computer game controller use for team play.

### BACKGROUND OF THE INVENTION

Game controllers, such as joysticks and gamepads, have been in use in game consoles and personal computers since their creation in the 1970s. Game play has been enhanced through creation of new controller types and the support of multiple controllers for multiple players.

### SUMMARY OF THE INVENTION

The invention creates a hardware or software or hardware/software control that will allow multiple physical game controllers to be seen as an individual virtual controller by a computer game. To the game, the virtual controller looks like a physical controller. The premise is that each individual physical controller output is used to build a composite output that represents the team output for the virtual controller. The software for the computer game does not require modifications to allow team play.

### BRIEF DESCRIPTION OF THE FIGURES

FIG. 1 is a standard connection diagram illustrating normal game control using standard game controllers.

FIG. 2 is a connection diagram illustrating a hardware solution showing physical controllers connected to a physical device that provides the virtual single device to the game machine

FIG. 3 is an electrical diagram illustrating the traditional hardware wiring for a controller with a single analog connection and two switches.

FIG. 4 is an electrical diagram illustrating the new technique of wiring controllers' analog connections and digital connections to provide team play for 3 game controllers.

FIG. 5 is a connection diagram illustrating a software solution showing physical controllers connected to the game machine and software inside the game machine provides a virtual device to games.

FIG. 6 is a software routine listing to show the software calculation for a virtual controller.

### DETAILED DESCRIPTION OF THE INVENTION

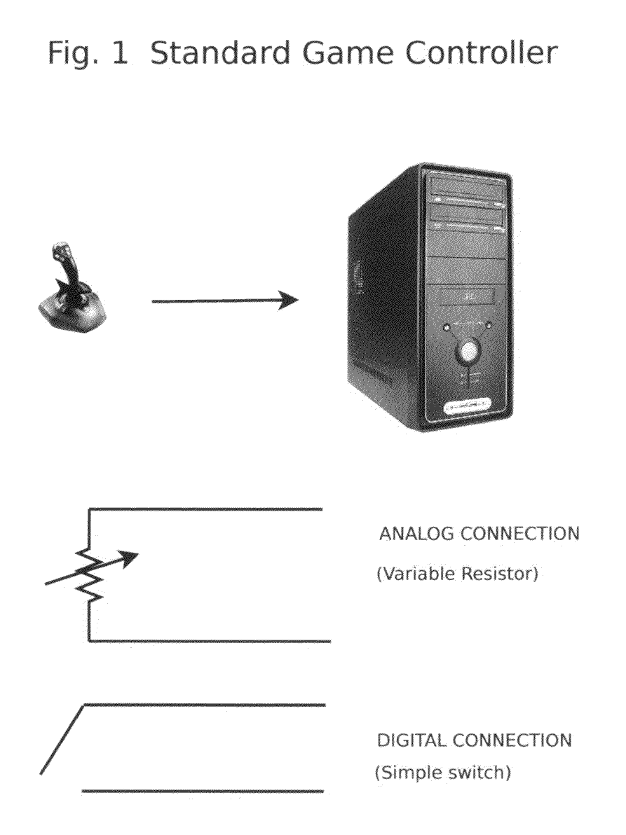

Referring to FIG. 1 there is shown two standard game controllers connected to a game console. Each controller can be used by one individual to play against each other or the computer. Individual games may support these controllers to work together as part of a team game (i.e. soccer game with each individual providing input to control different players on soccer field). Most games do not support team play explicitly. This figure can be considered the comparative baseline for the invention.

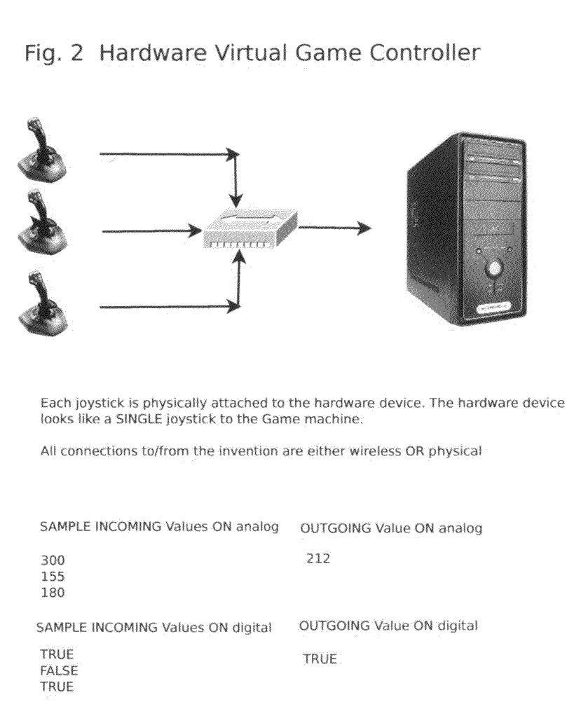

Referring to FIG. 2 there is shown a hardware implementation of the team play controller. Physical connections to the hardware device may be wired or wireless. Internally, the device obtains input from the controllers (typically using USB or serial or physical joystick/game port connectivity). The device internalizes all controller states to create a composite state that represents the virtual controller. Game controllers have analog and digital outputs. Composite analog states are created by averaging physical controller states to create a virtual analog state. Composite digital states are created by biasing TRUE connections. This means that if ONE physical control has a digital state of output as TRUE, the composite state of output is TRUE. If all physical controls for a digital state of output as FALSE, the composite state of output is FALSE. If an implementation is created using reverse logic, the states specified are reversed. It is possible to bias analog inputs to give different weightings for different physical controllers. In a smart device, this can be configured using http protocol interfaces. This type of controller transmits the virtual states to the game machine appearing to the game machine as one game controller.

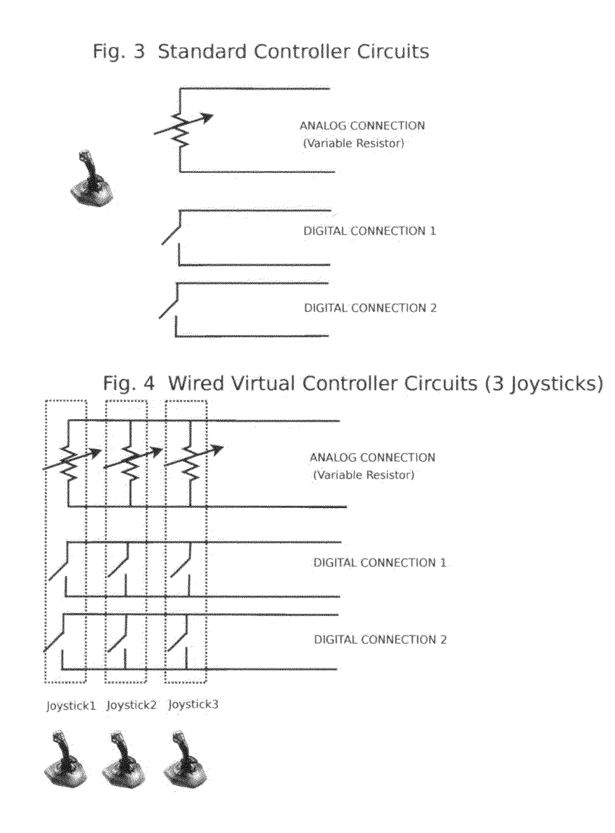

A pure traditional joystick/gamepad hardware implementation is also possible, FIG. 3 shows the traditional hardware implementation. The connection device is not required to be intelligent but may be implemented with wiring. Physical connections for analog inputs are wired in a parallel circuit. Physical connections for digital inputs are also wired in parallel. In traditional game controllers, analog input is implemented with variable resistors. There are no power sources on the controllers. Changes in resistance values are monitored. The parallel connectivity of the analog outputs allow a hardware averaging of resistance values. The physical joysticks may be modified to provide different resistances based on the number of players on a team. See FIG. 4 to view the single analog output wiring based on three game controllers. The analog variable resistance values for traditional joysticks and the required modification based on multiple users is as follows.

TABLE 1
Joystick Variable Resistance Co-Relation

| | Max. Variable | 1K Virtual Resistance |
|---|---|---|
| Number of Joysticks | Resistance (ohms) | (ohms) |
| 3 | 3000 | 1000 |
| 4 | 4000 | 1000 |
| 5 | 5000 | 1000 |
| 6 | 6000 | 1000 |
| 7 | 7000 | 1000 |
| 8 | 8000 | 1000 |
| 9 | 9000 | 1000 |
| 10 | 10000 | 1000 |
| 11 | 11000 | 1000 |
| 12 | 12000 | 1000 |
| 13 | 13000 | 1000 |
| 14 | 14000 | 1000 |
| 15 | 15000 | 1000 |
| 16 | 16000 | 1000 |
| 17 | 17000 | 1000 |
| 18 | 18000 | 1000 |

Using the formula

RT=1/(1/R1+1/R2+1/R3+ . . . )

and adjusting for identical joystick/gamepads where R1, R2, R3 and all others are identical resistance, the following formula is created.

RT=1/(1/MAX+1/MAX+1/MAX+ . . . )

This simplifies to

RT=1/(JOYSTICKS/MAX)

or

JOYSTICKS=(1/RT)*MAX

As the number of joysticks is increased, the variable resistor type must be changed to create the same virtual resistance value. Table 2 illustrates the virtual resistance values that occur if no adjustment is performed.

TABLE 2
Dual Joystick Analog Combination

| Joystick 1 | Joystick 2 | Virtual Joystick |
|---|---|---|
| (ohms) | (ohms) | (ohms) |
| 100 | 100 | 50 |
| 200 | 200 | 100 |
| 300 | 300 | 150 |
| 400 | 400 | 200 |
| 500 | 500 | 250 |
| 600 | 600 | 300 |
| 700 | 700 | 350 |
| 800 | 800 | 400 |
| 900 | 900 | 450 |
| 1000 | 1000 | 500 |
| 1100 | 1100 | 550 |
| 1200 | 1200 | 600 |
| 1300 | 1300 | 650 |
| 1400 | 1400 | 700 |
| 1500 | 1500 | 750 |
| 1600 | 1600 | 800 |

Selection of a variable resistor on the game controller would allow configuration of the controller for various size teams. Digital inputs on traditional game controllers are implemented with simple switches. See FIG. 4 for sample connectivity on one digital output with three game controllers. If a switch in closed, the output is TRUE. In a physically connected parallel network of switches, any switch closed produces a TRUE. All switches open produce a FALSE. This is the precise effect required for team play. If the game controllers are completely digital, no requirement for game controller modification is necessary.

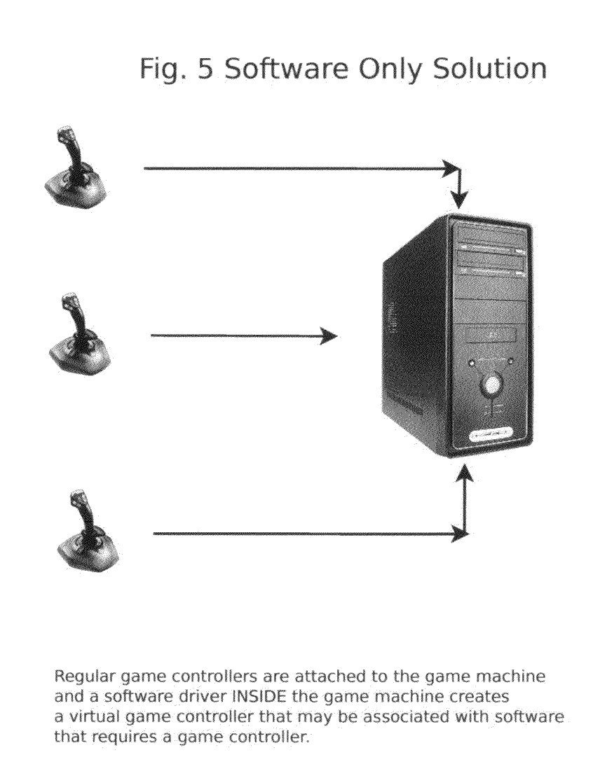

Referring to FIG. 5 there is shown a pure software implementation of the team play virtual controller. The physical controllers connect into the game machine directly (via wired or wireless connection). A software driver (user or kernel level) creates composite values based on the outputs from the physical controllers. For analog outputs, the driver averages all values that are accumulated from physical controller states. A biasing of values may be accomplished in software. The result of the computation is the state for the virtual controller which is a device selected for use in the game. Similarly, digital input is accumulated from the physical controller sources and used to produce an output for the virtual controller. Any TRUE state for a physical digital switch produces a TRUE state for the virtual switches output. All FALSE states for a physical switch produces a FALSE state for the virtual switch output. If an implementation is created using reverse logic, the states specified are reversed.

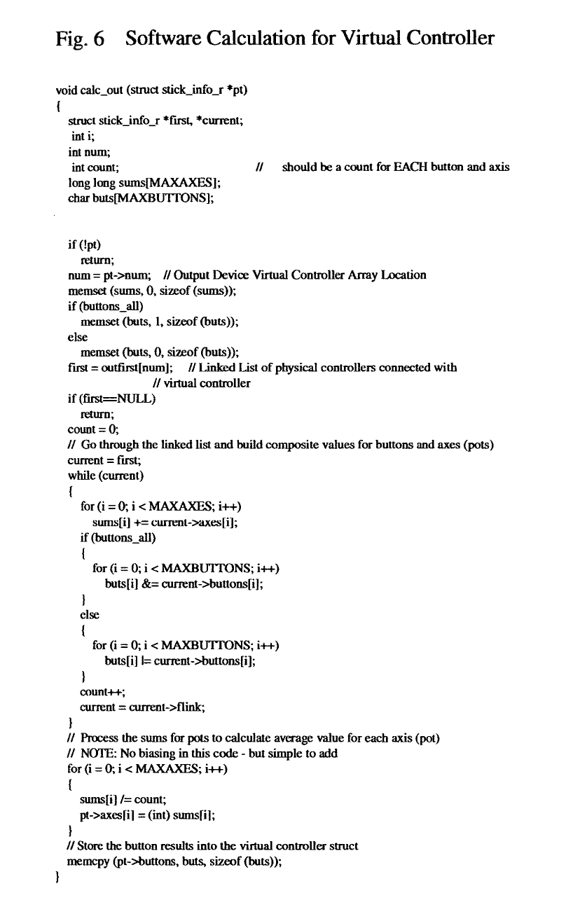

Referring to FIG. 6. the code demonstrates the software calculation of creating a virtual gamepad device (a virtual controller) in a Linux OS environment. Physical controllers have been polled (using threads) to retrieve their gamepad attributes. These attributes are stored inside an array of software structures. The virtual controller is also stored in an identical software structure. The routine builds the composite virtual controller values through calculations on the range of physical controller values. The gamepad buttons are examined and a new set of button values are created for the virtual controller. The gamepad analog potentiometers (pots) are examined and a new set of values generated for the virtual controller pots.

It should be apparent to one skilled in the art that there are many modifications and alternative configurations that can be employed. All of which are deemed to be encompassed with the spirit and scope of the claims appended hereto.

The invention claimed is:

1. A hardware device that works with one or more attached game controllers (wireless or wired) to produce outputs that correspond to a combination of the attached game controller states to represent a single game controller.

2. The hardware device of claim 1 that is created to make multiple virtual game controllers.

3. The hardware device of claim 2 that allows selection of connected physical controllers to join with a specific virtual controller.

4. A software system that joins connected game controllers together into a single virtual game controller implemented in either kernel space or user space.

5. A software system that joins connected game controllers together into a multiple virtual game controllers implemented in either kernel space or user space.

6. The hardware device of claim 1 that connects to consumer game consoles in either wired or wireless manner.

7. The software system of claim 4 that is embedded in consumer game consoles.

8. The hardware device of claim 1 that connects to personal computers in either wired or wireless manner.

9. The software system of claim 4 that is embedded in personal computers.

10. The hardware device of claim 1 that supports connections to motion control game controllers.

11. The hardware device of claim 1 that supports connections to music game controllers.

12. The hardware device of claim 1 that supports connections to joystick devices.

13. The hardware device of claim 1 that supports connections to analog/digital gamepads.

14. The hardware device of claim 1 that is implemented with pure hardware connectivity wiring game controller switches in parallel and analog connections in parallel.
